(19) United States
(12) Patent Application Publication
(10) Pub. No.: US 2006/0032043 A1
(43) Pub. Date: Feb. 16, 2006

(54) Method for packing transformer

(76) Inventor: Chih Hung Lin, Taipei Hsien (TW)

Correspondence Address: Chih Hung Lin, 235 Chung-Ho, Box 8-24, Taipei, TW

(21) Appl. No.: 11/165,517

(22) Filed: Jun. 24, 2005

(30) Foreign Application Priority Data
Aug. 11, 2004 (CN) 200410058420.1

(51) Int. Cl. H01F 27/28

(52) U.S. Cl. 29/602.1; 336/220; 29/855

(57) ABSTRACT

A method for insulating packing a transformer comprises the steps of combining a content of a transformer to a plurality of pins by leads; placing the content into a platform of a lower mold and fixing the pins by fixtures; sealing an upper mold to the lower mold and exposing parts of the pins; and filling insulating material into a space formed by the upper mold and the lower mold. The platform of the lower mold is at a top of the lower mold having a maximum area. When releasing the upper mold and the lower mold, the insulating material will enclose the iron core, coil, leads and pins so as to form an insulating casing. A part of the iron core is hollowed and then a lower density insulating glue is applied to the hollowed portion of the insulating casing.

### FIELD OF THE INVENTION

The present invention relates to transformers, and in particular to a method for insulating packing a transformer, wherein the transformer is a small component used in electric industry, in that a content usually comprises a coil, an iron core and a plurality of pins. In the manufacturing process, the insulating material will enclose the iron core, coil, leads and pins and then the parts of the exposed pins is connected with the exterior electric circuits.

### BACKGROUND OF THE INVENTION

In general, in the insulating packing technology, a mold is used to seal an object. Then insulating material (for example, plastics or ceramic) is filled into the mold so that the object is enclosed by the insulating material. Conventionally, as shown in FIGS. 1 to 3, the packing method of a small transformer comprises the steps of: adhering a plurality of leads 12 and a plurality of pins 13 to an iron core 11 of a transformer; wherein the iron core 11 is wound with a coil 10; positioning the pins 13 by a fixture; applying a layer of shaping glue to the transformer for fixing the transformer thereto; finally, sealing the objects by an upper mold 15 and a lower mold 16, only parts 131 of the pins 13 exposes out.

After the upper mold 15 and the lower mold 16 are sealed, the insulating material is filled into the space surrounded by the mold and then wait until it is cooled down for releasing the mold, see FIG. 3. The content of the transformer 2 is wounded by the insulating material 18. Only parts of exposed pins 131 are offered to link with exterior circuits. Besides, the exposed pins 131 are usually curved by a tool so as to be connected with the exterior circuits conveniently.

The finished transformer is usually applied to link electric circuits illustrated as FIG. 4. The transformer 1 is welded on a circuit board 19 already been set on electric circuits. The exposed pins 131 are used for be connected to the electric circuits of the circuit board 19. During the process of connecting the exposed pins 131 with the circuit board 19 (e.g. SMT), the exposed pins 131 of the transformer 2 is welded by high temperature to the circuit board 19.

Due to the limitation of the volume of the small transformer, it is obvious that the outer layer of the insulating material is thin. In particular, the bottom layer of the insulating material often exposes out due to near high temperature and incapable ventilation, which causes the damage content of the transformer. Thus it is difficult to increase the yield ratio of this type of transformers.

In addition to the above problem, the content of transformer is fixed by insulating glue and then measured some predetermined positions for setting in the conventional packing process, because the content of the transformer is set in the center of the sealed space of the mold, it will prevent from collision or extrusion in the sealing process. The conventional packing process not only wastes a lot of time, but also is inconvenient to mass production.

### SUMMARY OF THE INVENTION

Accordingly, the primary object of the present invention is to provide a new packing method of a transformer for reducing manufacturing time and increasing the yield ratio. Furthermore, the packing method of a transformer of the present invention resolves the problem of the cracking from the explosion of the insulating material of traditional transformer.

The main features of the packing method of the transformer of the present invention will be described herein. The platform of the lower mold is placed at a top of the lower mold having a maximum area. The platform is protruded into the space formed by the upper mold and the lower mold for placing the content. When releasing the upper mold and the lower mold, the insulating material will enclose the iron core, coil, leads and pins so as to form an insulating casing. A part of the iron core is hollowed and then a lower density of insulating glue is applied to the hollowed portion of the insulating casing. Since the density of the insulating glue is low, it has the effect of ventilation. By the principle of heat exchange, the insulating casing will not expose out due to high temperature. Furthermore, in the manufacturing process of the present invention, since the content is directly placed on the platform of the lower mold, no special measurement and calculation is need. It is assured that the upper mold will not be collided or extruded in the sealing process. As a result, the time for fixing the content by shaping glue is saved. Thereby the problem encountered in the conventional transformer is resolved.

The various objects and advantages of the present invention will be more readily understood from the following detailed description when read in conjunction with the appended drawing.

### BRIEF DESCRIPTION OF THE DRAWINGS

FIGS. 1 to 3 are perspective views for manufacturing methods and procedures of insulating packing of a transformer of a prior art.

FIG. 4 is a perspective view of combining a prior art transformer and a circuit board.

FIGS. 5 to 7 are perspective views for the manufacturing method of the insulating packing of a transformer of the present invention.

FIG. 8 is a lateral cross-sectional view of a transformer of the present invention.

FIG. 9 is an outer view of the transformer of the present invention.

FIG. 10 is a perspective view about the step of combining the transformer of the present invention and a circuit board.

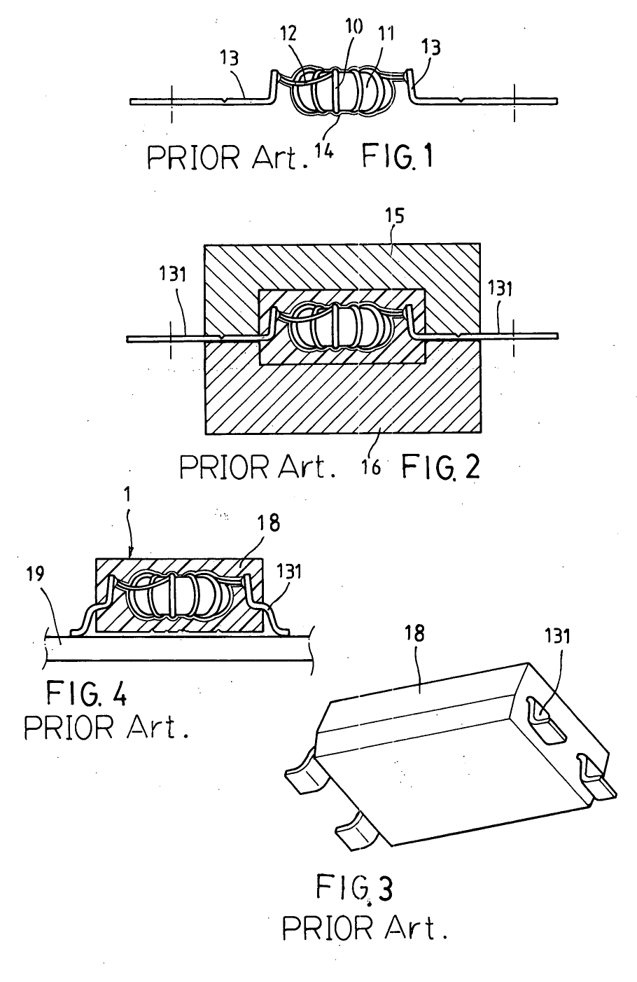

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

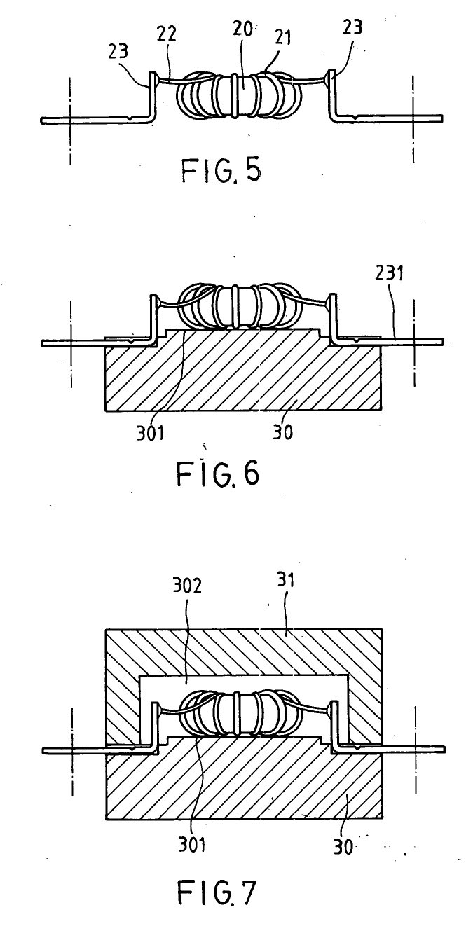

Referring to FIGS. 5 to 7, the process of the present invention will be described herein. The method comprises the steps of: see FIG. 5, combining a content, such as an iron core 20 and a coil 21, of a transformer to a plurality of pins 23 by leads 22; see FIG. 6, placing the content into a platform 301 of a lower mold 30 and fixing the pins by fixtures; referring to FIG. 7, sealing an upper mold 31 to the lower mold 30 and exposing parts 231 of the pins 23; and filling insulating material into a space formed by the upper mold 31 and the lower mold 30.

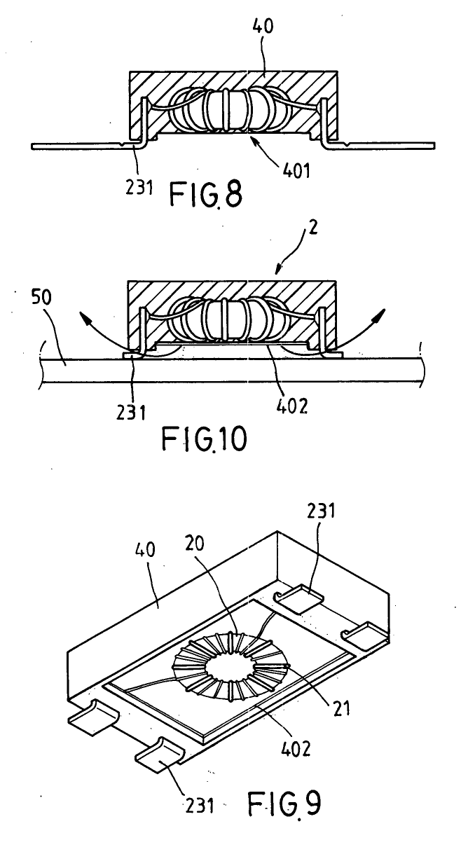

The platform 301 of the lower mold 30 is at a top of the lower mold 30 having a maximum area. The platform 301 protrudes into the space formed by the upper mold 31 and the lower mold 30 for placing the content. When releasing the upper mold 31 and the lower mold 30, the insulating material will enclose the iron core 20, coil 21, leads 22 and pins 23 so as to form an insulating casing 40, as illustrated in FIGS. 8 and 9. A part of the iron core 20 is hollowed so that the iron core 20 and coil 21 exposes out. A lower insulating glue 402 is applied to the hollowed portion 401 of the insulating casing 40. The density of the insulating glue 402 is lower than that of the insulating casing 40. With reference to FIG. 10, since the density of the insulating glue 402 is low, it has the effect of ventilation (as the arrow illustrated in FIG. 10). By the principle of heat exchange, when exposed pins 231 of the transformer 2 is welded to a circuit board 50, the insulating casing will not expose out due to high temperature.

In the manufacturing process of the present invention, since the iron core 20 and coil 21 are directly placed on the platform 301 of the lower mold 30, no special measurement and calculation is need. It is assured that the upper mold 31 will not be collided or extruded in the sealing process. As a result, the time for fixing the iron core 20 and coil 21 by shaping glue is saved. Thereby the problem encountered in the conventional transformer is resolved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for packing a transformer comprising the steps:
using leads to combin a content of a transformer to a plurality of pins;
placing the content into a platform of a lower mold and fixing the pins by fixtures;
sealing an upper mold to the lower mold and exposing parts of the pins; and
filling insulating material into a space formed by the upper mold and the lower mold;
wherein the platform of the lower mold is located at a top of the lower mold which has a maximum area, the platform protrudes into the space formed by the upper mold and the lower mold for placing the content; when releasing the upper mold and the lower mold, the insulating material will enclose the content; leads and pins so as to form an insulating casing; a part of the iron core is hollowed so that the iron core and coil expose out; and lower density insulating glue is applied to the hollowed portion of the insulating casing; the density of the insulating glue is lower than that of the insulating casing; since the density of the insulating glue is low, it has the effect of ventilation.

2. The method for packing a transformer as claimed in claim 1, wherein the content includes an iron core and a coil.

3. A packing structure for insulating a transformer comprising;
a layer of insulating casing enclosing the transformer;
a lower insulating glue applied to the hollowed portion of the insulating casing; the density of the insulating glue is lower than that of the insulating casing; since the density of the insulating glue is low, it has the effect of ventilation.

4. The method for packing a transformer as claimed in claim 3, wherein the content includes an iron core and a coil.
